(19) United States
(12) Patent Application Publication
(10) Pub. No.: US 2019/0063647 A1
(43) Pub. Date: Feb. 28, 2019

(54) FULL-FACE FLARE JOINT FOR LINED PIPING SYSTEM

(71) Applicant: JUST DIMENSION PTE. LTD., Singapore (SG)

(72) Inventor: Yong Ann Jeffrey LIM, Singapore (SG)

(21) Appl. No.: 15/742,784

(22) PCT Filed: Aug. 30, 2017
(86) PCT No.: PCT/SG2017/050427

§ 371 Date: Jan. 8, 2018

(51) Int. Cl. F16L 23/12; F16L 23/028; F16L 58/18

(52) U.S. Cl. CPC F16L 23/125; F16L 58/187; F16L 23/0283

(57) ABSTRACT

A full-face flare joint for a lined piping system having a connector portion of a metal piping being flared radially outwardly at a predetermined angle to form a pipe lap with a first surface and a second surface. The first surface is configured to engage a pipe flange. Further, a pipe lining extends out of the connector portion and is flared radially outwardly over the second surface of the pipe lap thereby forming a liner flare. A full-face flare component with a bottom portion is attached to the liner flare so that the bottom portion of the component forms an angle of about 90° with an inner surface of the pipe lining.

### BACKGROUND OF THE INVENTION

### Field of the Invention

The present invention relates to joints for lined piping systems and, more particularly, to a full-face flare joint for a PTFE lined piping system that minimizes the formation of crevices in the PTFE lined piping system, and to a method of manufacturing the full-face flare joint for the lined piping system.

### Description of the Background Art

In lined piping systems, a metal pipe is lined with a non-metallic material. The non-metallic material can be selected from, for example, elastomers and plastomers.

The lined piping systems are generally fabricated from carbon steel and lined with various chemically resistant plastics having nominal wall thicknesses usually ranging from about 0.054″ to about 0.185″ or greater for polytetrafluoroethylene (PTFE) resin, and thicker for other resins such as polypropylene.

The PTFE lined pipes allow for a mechanically durable and relatively inexpensive pipe and fitting for safe handling of corrosive and/or dangerous materials in, for example, chemical process industries. The PTFE lined pipes are known for their inert and non-stick characteristics, and are also used where contamination cannot be tolerated in the processed fluids.

There are several types of PTFE liners currently in use, including, for example, Isostatic Molded Liners, Paste Extrusion Liners, and Ram Extrusion Liners. Isostatic Molded Liners are manufactured by compacting granular PTFE resin under high pressure and then sintering it to form long liner tubes. Paste Extrusion Liners are produced when fine powder PTFE resin is mixed with lubricant and compressed into a billet. This billet is then pressed through a die and core-pin in an extrusion chamber into a tube. The tube is then heated to remove the lubricant and then sintered. Ram Extrusion Liners are produced by a process where granular PTFE resin is fed into a charging unit and compacted to form a continuous tube. The tube is then put through heated sections at sintering temperature and cooled.

Generally, connections are made between sections of such pipes by flange joints. Here, the lining is brought out of the pipe and flared over the face of the flange in order to protect the metal from the fluids being carried. This process results in a flared rounded corner over the portion of the flange that is closest to the liner.

With the lined pipe, there is a certain minimum requirement for the radial dimension of the lining that is flared over the flange face. The reason for the requirement is that cold flow (i.e., deformation of the liner under the influence of mechanical stresses) is of such significance that the flare must have at least some minimum radial dimension between its inside and outside diameters for each pipe size in order to prevent leakage in the joints.

In accordance with the engineering standard ASTM F1545-15a section 4.2.3, all steel pipe and fitting end connections must have a ⅛″ (3 mm) radius in transition from the pipe wall to the flange or lap face. Traditionally, the setback of having a round flare corner was tolerated for the more important benefits of using the PTFE lined pipes.

Historically, when PTFE was first used in a pipe lining, the target market was process plants handling corrosive and hazardous chemicals. Crevices were not an issue, as the integrity of the fluids was not a concern. Since then, flaring methods incorporated by the manufacturers generally have a 3 mm radius, resulting in a rounded corner.

When the two opposite flange faces are joined to form a flared joint, the rounded corners of the two opposite flanges form crevices that can trap residue and particles, thereby contaminating the fluids passing through the lined pipe system. Moreover, the process of residue buildup being trapped in the crevices around the joints may cause the joints to fail over time.

The PTFE lined pipes are normally produced in maximum lengths of 6 m, resulting in numerous numbers of flange joints in the piping systems. The large number of joints that trap residue causes substantial and often irreversible failures of the lined pipe systems.

In order to address the foregoing issues, several alternative methods have been used. For example, pipes and fittings made from alloy steel (i.e. exotic metals) have been used. These exotic metals pipes and fittings have the advantage that they can be joined by streamlined butt welded joints, thereby eliminating flanges. However, there are numerous disadvantages of using these exotic metals pipes and fittings. For example, the cost of such exotic metals pipes and fittings is high and special welding techniques and specialist welders are required. Further, the chemical resistance of these pipes and fittings is limited within a specific range of operating conditions. If conditions deviate, chemical reactions and/or deterioration of the pipes and fittings will occur.

Another system that is used to combat the drawback of having crevices resulting from the flange joints is Conquest® Pipe by Crane Resistoflex. This is essentially a flangeless PTFE lined piping system. In this system, the inner PTFE liner is butt joined by fluoropolymer welding and the steel flange is replaced by a mechanical coupling. Although not marketed as a crevice-free lined piping system, it can qualify as a cavity-free piping system by nature of the butt welded joints. This system claims to reduce the number of flange connections in process piping systems by up to 95%, thus minimizing potential chemical leaks and fugitive emissions.

The known disadvantages of the Conquest® Pipe are high installation costs, certified specialist pipe fitters are required, and pipes are difficult to repair if the butt joint welding fails. Also, because the PTFE liner used by the Conquest® Pipe is of the isostatic type, these pipes are not suitable for all industries due to their coarse surface finish.

Accordingly, as discussed above, there is a need for a piping system that is capable of supporting the quality and integrity of a high level of fluids by substantially reducing contamination of the fluids and effective cleaning and maintenance.

Further, there is a need for reduction of leaks in the piping system, especially when the piping system is handling dangerous and hazardous fluids.

It is therefore an object of this invention to disclose a full-face flare joint for a PTFE lined piping system that minimizes the formation of crevices in the PTFE lined piping system, thereby improving the integrity and sealing of the piping system, as well as facilitating “in-situ” sanitary cleaning and flushing.

It is a further object of this invention to disclose a method of manufacturing the full-face flare joint for the lined piping system.

### SUMMARY OF THE INVENTION

The present invention discloses a full-face flare joint for a lined piping system comprising a connector portion of a metal piping being flared radially outwardly at a predetermined angle to form a pipe lap. The pipe lap has a first surface and a second surface. The first surface is configured to engage a pipe flange.

Further, a pipe lining extends out of the connector portion and is flared radially outwardly over the second surface of the pipe lap, thereby forming a liner flare.

The joint further comprises a full-face flare component which is attached to the liner flare. The component includes a bottom portion. The full-face flare component is configured to be attached to the liner flare so that the bottom portion forms a right angle with an inner surface of the pipe lining.

In an embodiment of the present disclosure, the pipe lining is manufactured from polytetrafluoroethylene (PTFE) resin. In a preferred embodiment, the pipe lining and the full-face flare component is made of Dyneon™ TFM™ PTFE.

In another embodiment of the present disclosure, a backing-corner component is placed between the second surface of the pipe lap and the liner flare. The backing-corner component is configured to form a liner flare angle of about 90°.

In yet another embodiment of the present disclosure, the pipe lining is wrapped by a perfluoroalkoxy alkane (PFA) film. The pipe lining is then flared radially outwardly over the second surface of the pipe lap, thereby forming the liner flare. The PFA film wrap facilitates formation of a liner flare angle of about 90°.

The present invention further discloses a method for manufacturing the full-face flare joint for a polytetrafluoroethylene (PTFE) lined piping system. The method comprises flaring the connector portion of the metal piping outwardly at a predetermined angle to form the pipe lap. The pipe lap has a first surface and a second surface. The first surface is configured to engage the pipe flange.

The pipe lining is then extended out of the connector portion. The pipe lining is then flared radially outwardly over the second surface of the pipe lap, thereby forming the liner flare.

The full-face flare component is then attached to the liner flare, where the full-face flare component has a bottom portion that forms a liner flare angle of about 90° with the inner surface of the pipe lining.

The terms “comprising,” “having,” “including,” and “containing” as used herein, means that various additional components can be conjointly employed in the configuration of this invention as long as the full-face flare joint for the lined piping system performs its intended functions.

### BRIEF DESCRIPTION OF THE DRAWINGS

The present invention will become more fully understood from the detailed description given herein below and the accompanying drawings, which are given by way of illustration only, and thus do not limit the present invention, and wherein:

FIG. 1 is a cross-sectional view of a flange joint for a lined piping system according to the prior art;

FIG. 2 is an illustration comparing cross-sectional views of the flange joint according to the prior art with a full-face flare joint for the lined piping system according to an embodiment of this disclosure;

FIG. 3 is a cross-sectional view of the full-face flare joint according to an embodiment of this disclosure;

FIG. 4 is a cross-sectional view of the full-face flare joint according to another embodiment of this disclosure;

FIG. 5. is a cross-sectional view of the full-face flare joint showing a backing-corner component according to an embodiment of this disclosure;

FIG. 6. is a cross-sectional view of the full-face flare joint according to yet another embodiment of this disclosure; and

FIG. 7 is a cross-sectional view of the full-face flare joint showing the pipe lining being wrapped by a film according to another embodiment of this disclosure.

### DETAILED DESCRIPTION OF THE PREFERRED EMBODIMENTS

The following definitions and non-limiting guidelines must be considered in reviewing the description of this invention set forth herein. The headings (such as “Background” and “Summary”) used herein are intended only for general organization of topics within the disclosure of the invention, and are not intended to limit the disclosure of the invention or any aspect thereof. In particular, subject matter disclosed in the “Background” may include aspects of technology within the scope of the invention, and may not constitute a recitation of prior art. Subject matter disclosed in the “Summary” is not an exhaustive or complete disclosure of the entire scope of the invention or any embodiments thereof.

The citation of references herein does not constitute an admission that those references are prior art or have any relevance to the patentability of the invention disclosed herein. Any discussion of the content of references cited is intended merely to provide a general summary of assertions made by the authors of the references, and does not constitute an admission as to the accuracy of the content of such references. All references cited in the Description section of this specification are hereby incorporated by reference in their entirety.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “about,” when applied to the value for a parameter of a composition or method of this invention, indicates that the calculation or the measurement of the value allows some slight imprecision without having a substantial effect on the chemical or physical attributes of the composition or method.

Exemplary embodiments of the invention will be described in detail below. While the invention is applicable to any disconnectable joint formed in a lined piping, it is best described with reference to the connection of two pipe ends.

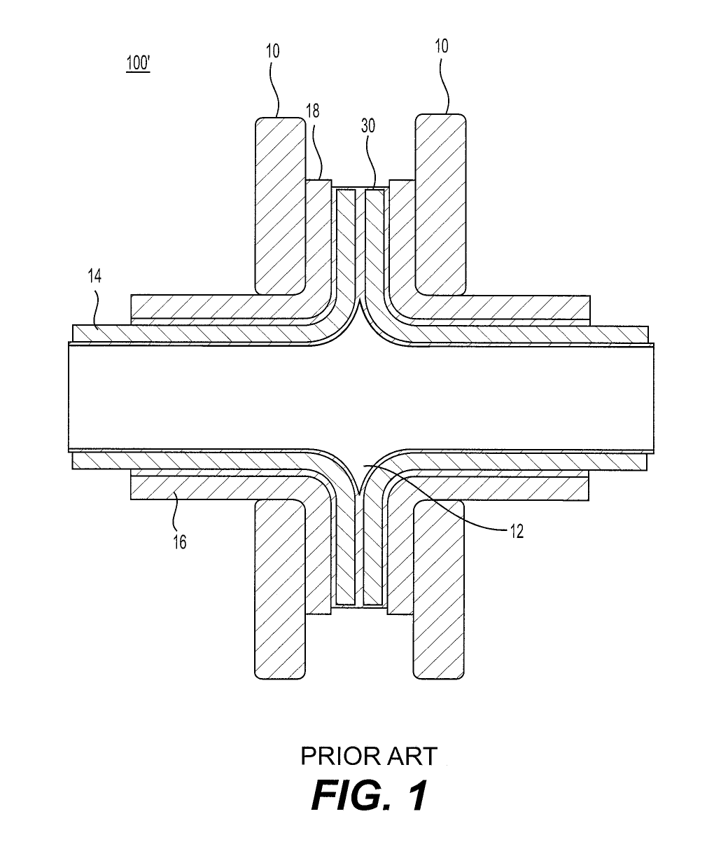

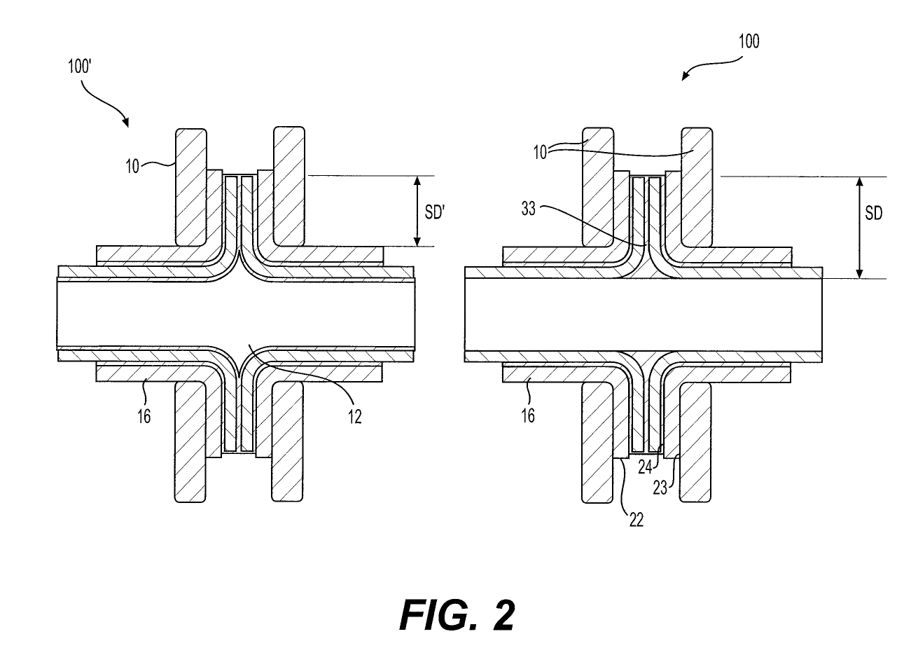

Referring to the drawings, FIG. 1 and FIG. 2 illustrate the conventional flare joint 100′ having two opposite flanges 10 being joined to form the flare joint 100′.

Conventionally, as shown in FIGS. 1 and 2, a metal piping 16 is flared radially outwardly to form a pipe lap 18. The flaring of the metal piping results in a rounded corner of the flare. In accordance with the engineering standard ASTM F1545-15a section 4.2.3, all steel pipe and fitting end connections must have a ⅛″ (3 mm) radius in transition from a pipe wall to the flange or lap face. The general industry standard is to tolerate a 3 mm radius in the steel flaring corner, thereby resulting in the rounded corner.

Generally, in lined piping systems shown, for example, in FIGS. 1 and 2, the liner 14 is flared radially outwardly following the trajectory of the flaring of the metal piping. Accordingly, the liner has the same (i.e., 3 mm) radius in transition as the metal piping.

When the flanges 10 are drawn together to form the conventional joint, the rounded corners of the two opposite liner flares 30 form a crevice 12. This is due to the radius in transition described above, as illustrated in FIGS. 1 and 2.

The crevices 12 are known to trap, among other things, residue and particles, thereby contaminating the fluids passing through the lined pipe system during use. Moreover, the process of residue buildup in the crevices 12 may, over time, cause the joints to fail.

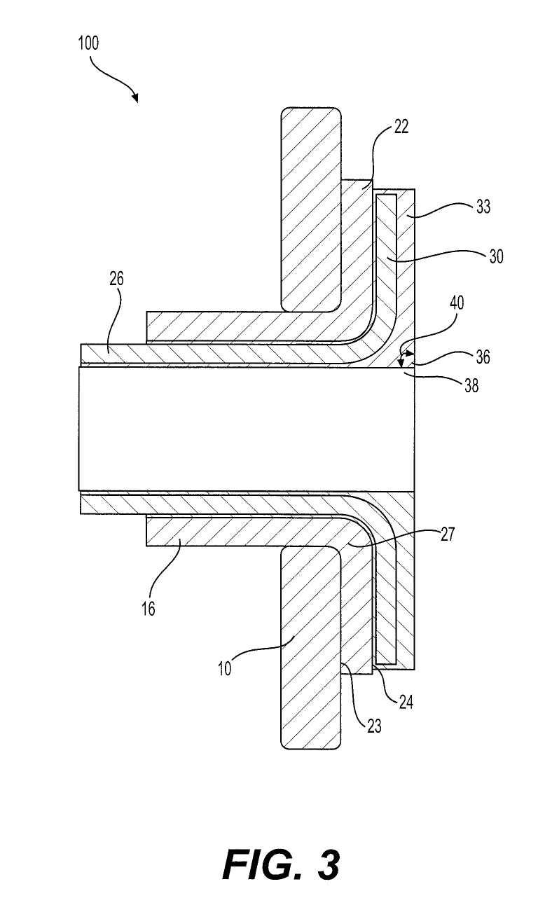

In an embodiment of the present disclosure, shown in more detail in FIG. 3, the full-face flare joint 100 for the lined piping system comprises a connector portion 27 of a metal piping 16 being flared radially outwardly to form a pipe lap 22.

The pipe lap 22 has a first surface 23 and a second surface 24. The first surface 23 is configured to engage the pipe flanges 10.

Further, a pipe lining 26 extends out of the connector portion 27 and is flared radially outwardly over the second surface 24 of the pipe lap 22, thereby forming a liner flare 30.

Further, the full-face flare joint 100 comprises a full-face flare component 33 attached to the liner flare 30. The full-face flare component 33 includes a bottom portion 36. When the component 33 is attached to the liner flare 30, the bottom portion 36 of the component 33 and an inner surface 38 of the pipe lining 26 form an angle 40 of about 90°.

When the two sides of the joint are being joined to form the full-face flare joint 100, no crevice is created, as illustrated in FIG. 2. That is, the two full-face flare components 30 (from each side of the joint) each have an angle 40 of about 90° when joined, thereby providing for a continuous inner surface of the pipe lining at the joints. Preferably, a frame or clamping assembly is used to join the two sides of the pipe and to ease the use of the present disclosure in the field.

This configuration results in substantial benefits for the lined piping system. For example, the full-face flare joint 100 according to this disclosure substantially reduces residue retention and collection of impurities in process pipelines as a result of eliminating the crevices 12. In addition, “in-situ” sanitary cleaning and flushing of the lined piping system is substantially more effective.

Even further, the full-face flare joint 100 according to this disclosure allows for a sealing area SD of the joint to be larger than a sealing area SD′ in the conventional joint, as illustrated in FIG. 2. The resulting larger sealing area allows for more effective seal strength and prevents leakage, cold flow, loss of the seal integrity, and failure. This is even more beneficial to the industries where lined piping systems are used at high temperatures and pressure process applications, for example, in chemical and pharmaceutical industries, as the configuration of the present disclosure allows for high level of seal integrity under high temperature and pressure.

In an embodiment of the present disclosure, the full-face flare joint 100 can further include a machined circular edge opposite to the angle 40. This will allow for a precise alignment with the liner flare 30, thereby improving the flow in the lined piping system.

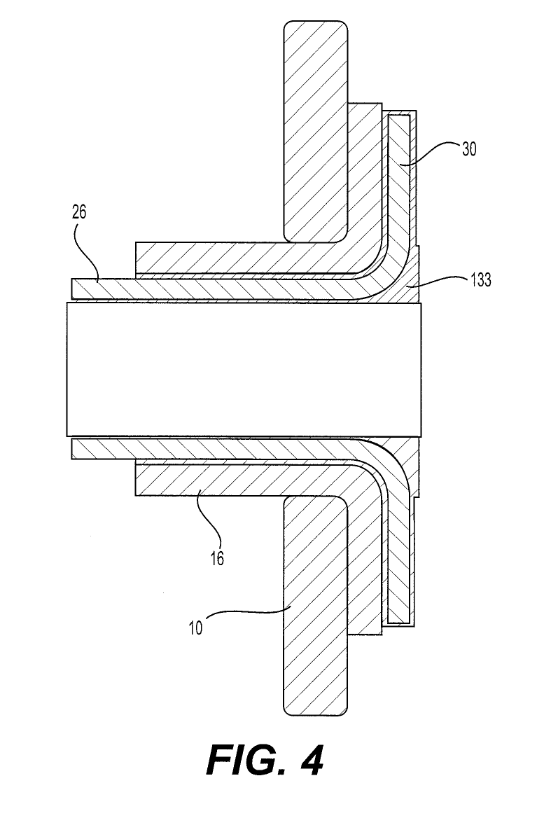

In another embodiment of the present disclosure, shown in FIG. 4, the full-face flare component 133 may be manufactured as a squared-corner ring. This square-corner ring may have the outside diameter to cover over the rounded corner of flare 30, which will vary in relation to the size of the pipe.

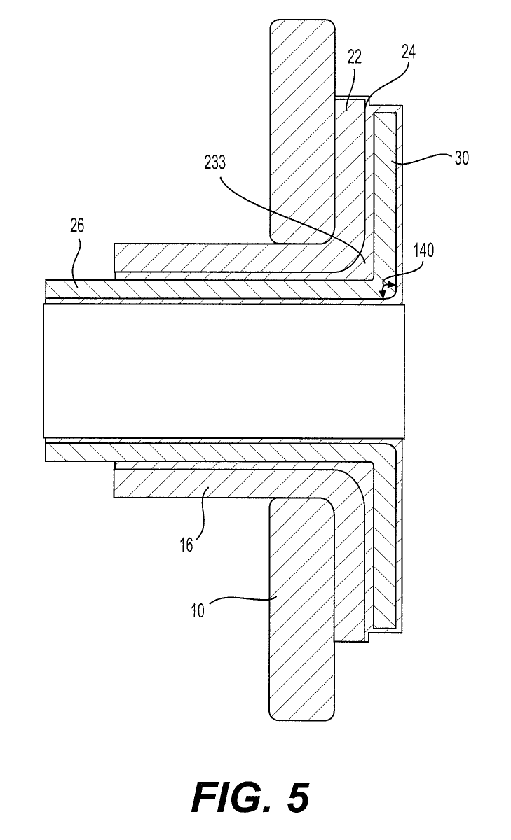

In another embodiment of the present disclosure, shown in FIG. 5, the full-face flare component 233 may be inserted into the void between the second surface 24 of the pipe lap 22 and the liner flare 30. The “backing-corner” component 233 is configured to form a liner flare angle 140 of about 90° by pushing a lower portion of the liner flare outwards.

In this embodiment, the component 233 is preferably welded to the pipe lining 26 by fluoropolymer welding technique in order to provide additional reinforcement and strength. Additionally, perfluoroalkoxy alkane (PFA) film may be used as a filler material to facilitate the attachment of the component 233 to the pipe lining 26.

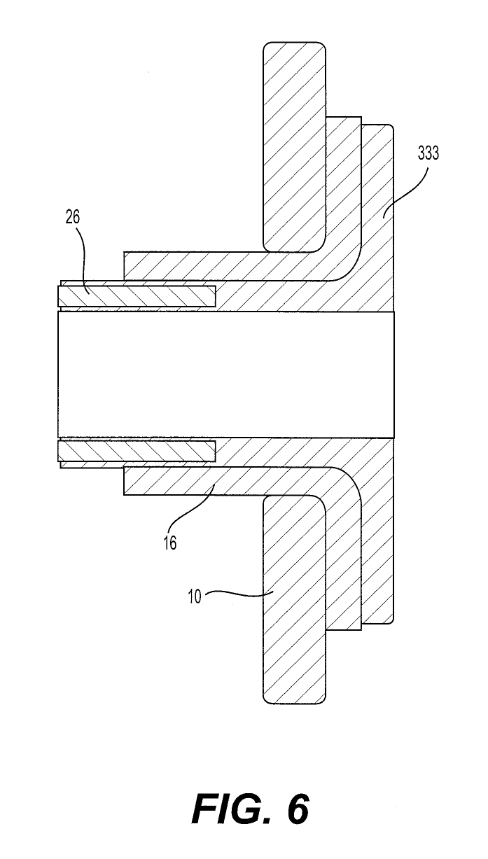

In yet another embodiment, as illustrated in FIG. 6, the full-flare component 333 is a stub that is welded on the liner flare 30 (not shown). The stub is welded on the liner flare and configured to provide a liner flare angle of about 90°.

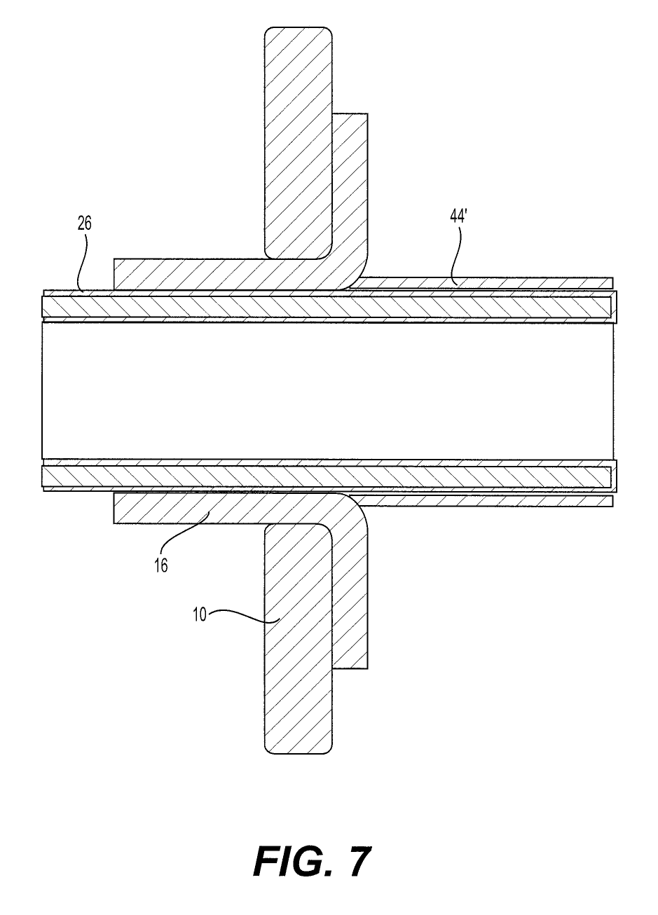

In yet another embodiment, as illustrated in FIG. 7, the pipe lining 26 is wrapped by a film 44, preferably made from perfluoroalkoxy alkane (PFA). The pipe lining 26 is flared radially outwardly over the second surface 24 of the pipe lap 22 and forms a liner flare (not shown). The PFA film wrap facilitates the formation of a liner flare angle of substantially 90°.

The metal piping 16 according to the present disclosure is made from rigid metal or flexible metal tubing. Preferably, the metal piping is made from carbon steel. Beneficial effects are also seen for pipes that are made from other substrates, such as aluminum, stainless steel and other corrosion resistant alloys.

The size of the pipe is not critical, however, the pipe preferably has a diameter of from about 1 inch to about 12 inches.

The thickness of the pipe lining 26 depends upon the size of the pipe. Generally, for a pipe having a diameter of from 1 inch to 3 inches, the thickness of the pipe lining 26 is preferably from about 0.1 inches to about 0.15 inches. For a pipe having a diameter of from 4 inches to 6 inches, the thickness of the lining is preferably from about 0.100 inches to about 0.175 inches. Most preferably, the pipe lining 26 is from about 0.129 inches to about 0.425 inches. More details about PTFE liners can be found in U.S. Pat. Nos. 4,203,938, 4,430,282 and 4,350,653.

In an embodiment of the present disclosure, the pipe lining may be manufactured from fluoropolymeric material. Preferably, the pipe lining is a perfluoroalkoxy (PFA), a polytetrafluoroethylene (PTFE) polymer, or a modified PTFE polymer filler. Modified PTFE polymers include those PTFE resins which have been modified specifically for improved weld strength or lower permeability. For example, modified PTFE resins include an additive which is added during polymerization in an amount around 0.10% by weight. Examples of modified PTFE polymers include TFM4215 and TFM1602, both available from Dyneon™.

More specifically, PTFE is inert to an exhaustive range of industrial chemicals. Its non-stick characteristic resists the build-up of deposits, reduces clogging problems, and is better for handling sticky resins and foodstuffs. Generally, PTFE should not be used with molten alkali metals (such as metallic sodium), fluorine and strong fluorinated agents. In a preferred embodiment, the pipe lining is made of Dyneon™ TFM™.

Another suitable polymer PFA is a perfluoropolymer which has essentially the same chemical resistance as PTFE and has added moulding properties ideal for lining complex shapes. PFA is extensively used in ultra-pure applications. It has excellent creep resistance at high temperatures with good flame resistance, and is reasonably tough at low temperatures. According to this disclosure, PFA can be used in combination with a PTFE lined pipe for handling most chemical fluids.

Polyvinylidene fluoride (PVDF) can also be used in the pipe lining. PVDF is a crystalline fluorinated polymer which is able to resist most inorganic acids and bases such as aliphatic and aromatic hydrocarbons and, particularly, the halogens, bromine and chlorine. Its better elongated property is suitable for thermal cycling up to its temperature limit. PVDF has good abrasion and permeation resistance but, being partially fluorinated, its chemical resistance is limited by temperature and concentration of the fluid.

In addition, polypropylene copolymer (PP) can be used in the pipe lining. PP is an inexpensive heat stabilized copolymer with good mechanical and chemical properties. It is ideal as a general purpose lining material for pipe, fittings and special fabrications normally used for water treatment, hot effluent lines, pickling, and plating.

The following example of the pipe lining parameters is set forth in Table 1 below to further illustrate the invention and are not to be construed as limiting.

TABLE I

| | PTFE | PFA | PVDF | PP |
|---|---|---|---|---|
| Specific Weight (g/cm3) | 2.14-2.19 | 2.12-2.17 | 1.75-1.78 | 0.9-0.92 |
| Elongation (%) | 200-400 | 300-400 | 10-300 | 10-600 |
| Tensile Strength (Mpa) | 20-40 | 27-32 | 40-50 | 20-40 |
| Max. Service Temp (° C.) | 200 | 200 | 140 | 100 |
| Melting Point (° C.) | 327-342 | 300-310 | 165-178 | 158-167 |
| Thermal Conductance | 9.65 | 7.38 | 9.09 | 4.54 |
| (W/m2h° C.) | | | | |

An exemplary method for manufacturing the full-face flare joint 100 for a polytetrafluoroethylene (PTFE) lined piping system comprises the steps of flaring the connector portion 27 of the metal piping 16 outwardly at a predetermined angle to form the pipe lap 22. The pipe lap has a first surface 23 and a second surface 24. The first surface is configured to engage the pipe flange.

The pipe lining 26 is then extended out of the connector portion 27. The pipe lining is then flared radially outwardly over the second surface 24 of the pipe lap 22 thereby forming the liner flare 30.

The full-face flare component 33 is then attached to the liner flare 30 so that the bottom portion 36 of the full-face flare component 33 and the inner surface 38 of the pipe lining 26 form an angle 40 of about 90°.

In the embodiment using PFA as an interlayer, the PFA layer may be applied to the end of the PTFE pipe lining using any suitable means. For example, the PFA can be dispersed in a carrier fluid and sprayed on the end of the PTFE pipe lining. Alternatively, a PFA film or a ring of PFA can be placed against the end of the PTFE pipe lining as the opposing surface is brought into contact with the PTFE pipe lining.

Preferably, the full-face flare component 33 is attached to the liner flare 30 by a method for fluoropolymeric welding, for example, a method described in U.S. Pat. No. 6,228,204 B1.

Preferably during welding, the weld has integrity which is equivalent to the pipe lining materials (e.g. PTFE). The integrity of the weld can be determined using any suitable method. Such methods are commonly used and are well known in the art.

All percentages, parts, and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Uses of singular terms such as “a,” “an,” are intended to cover both the singular and the plural, unless otherwise indicated herein or clearly contradicted by context. All references, including publications, patent applications, and patents, cited herein are hereby incorporated by reference. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A full-face flare joint for a lined piping system, comprising:
a connector portion of a metal piping being flared radially outwardly at a predetermined angle to form a pipe lap having a first surface and a second surface, wherein the first surface is configured to engage a pipe flange;
a pipe lining extending out of the connector portion, wherein the pipe lining is flared radially outwardly over the second surface of the pipe lap thereby forming a liner flare; and
a full-face flare component attached to the liner flare and having a bottom portion that forms an angle of about 90° with an inner surface of the pipe lining.

2. The full-face flare joint of claim 1, wherein the pipe lining is manufactured from polytetrafluoroethylene (PTFE) resin.

3. The full-face flare joint of claim 1, wherein the full-face flare component is attached to the pipe liner by fluoropolymer fusion welding.

4. The full-face flare joint of claim 1, wherein the full-face flare component further comprises a rearward facing side having a machined circular edge that coincides with the predetermined angle.

5. The full-face flare joint of claim 1, wherein the full-face flare component is a squared corner ring.

6. A full-face flare joint for a polytetrafluoroethylene (PTFE) lined piping system, comprising:
a connector portion of a metal piping being flared radially outwardly at a predetermined angle to form a pipe lap having a first surface and a second surface, wherein the first surface is configured to engage a pipe flange;
a PTFE pipe lining extending out of the connector portion, wherein the pipe lining is flared radially outwardly over the second surface of the pipe lap thereby forming a liner flare; and
a backing-corner component placed between the second surface of the pipe lap and the liner flare, wherein the liner flare forms an angle of about 90°.

7. A joint for a lined piping system, comprising:
a connector portion of a metal piping being flared radially outwardly at a predetermined angle to form a pipe lap having a first surface and a second surface, wherein the first surface is configured to engage a pipe flange;
a polytetrafluoroethylene (PTFE) pipe lining extending out of the connector portion, wherein the pipe lining is wrapped by a perfluoroalkoxy alkane (PFA) film, and wherein the pipe lining is flared radially outwardly over the second surface of the pipe lap thereby forming a liner flare, wherein the liner flare forms an angle of about 90°.

8. The joint of claim 7, wherein the perfluoroalkoxy alkane (PFA) film is welded on to the polytetrafluoroethylene (PTFE) pipe lining.

9. A method for manufacturing a joint for a polytetrafluoroethylene (PTFE) lined piping system, comprising the steps of:
flaring a connector portion of a metal piping outwardly at a predetermined angle to form a pipe lap having a first surface and a second surface, wherein the first surface is configured to engage a pipe flange;
extending a pipe lining out of the connector portion, wherein the pipe lining is flared radially outwardly over the second surface of the pipe lap thereby forming a liner flare; and
attaching a full-face flare component to the liner flare, wherein the full-face flare component has a bottom portion that forms an angle of about 90° with an inner surface of the pipe lining.

10. The method of claim 9, wherein the full-face flare component is attached to the liner flare by fluoropolymer fusion welding.

11. The method of claim 9, further comprising manufacturing the full-face flare component by using computer control numerical (CNC) process.

12. The method of claim 9, further comprising manufacturing the full-face flare component by compression molding process.

13. The method of claim 9, further comprising grounding the bottom portion of the full-face flare component to achieve the angle of about 90°.
